(19) United States
(12) Patent Application Publication
(10) Pub. No.: US 2019/0256068 A1
(43) Pub. Date: Aug. 22, 2019

(54) VALVE BODY FOR A BRAKE SYSTEM OF A MOTOR VEHICLE AND HYDRAULIC UNIT

(71) Applicant: Robert Bosch GmbH, Stuttgart (DE)

(72) Inventors: Axel Kiersten, Oberstenfeld (DE); Julian Zarges, Kempten (DE); Marco Mueller, Durach (DE); Rainer Schwarz, Immenstadt (DE); Thomas Kaserer, Ofterschwang (DE)

(21) Appl. No.: 16/346,342

(22) PCT Filed: Sep. 12, 2017
(86) PCT No.: PCT/EP2017/072830

§ 371 Date: Apr. 30, 2019

(30) Foreign Application Priority Data
Nov. 2, 2016 (DE) 10 2016 221 443.8

(51) Int. Cl. B60T 8/36; B60T 17/02; F16K 5/06; F04B 53/10; F04B 53/16

(52) U.S. Cl. CPC B60T 8/368; B60T 17/02; F04B 53/16; F04B 53/10; F16K 5/0642

(57) ABSTRACT

A valve body is described for a braking system of a motor vehicle, having an insulating element inserted into a passthrough opening of the valve body, which is embodied to insulate a contact pin with respect to a surface of the passthrough opening, the insulating element being embodied integrally with the passthrough opening. A hydraulic unit is described for the braking system of the motor vehicle.

### FIELD OF THE INVENTION

The present invention relates to a valve body for a braking system of a motor vehicle. The invention furthermore relates to a hydraulic unit for a braking system of a motor vehicle.

### BACKGROUND INFORMATION

In present-day brake regulating systems, electrical drives are used to drive the hydraulic pump. In all units, the valves are pressed into an aluminum valve body. The control device is bolt-mounted on the one side of the valve body; the electric motor is flange-mounted on the other side of the valve body. Electrical contacting between the motor and control device is accomplished via contact pins that are guided in one or several bores through the valve body. The insulation of the contact pins is pressed onto the contacts, or the contacts are directly overmolded with plastic.

German Published Patent Appln. No 10 2013 226 699 discloses an assemblage for controlling a medium. The assemblage has for that purpose a drive module, two pump modules, and a valve module having a circuit for controlling the medium conveyed through the pump modules. The assemblage for controlling the medium can be configured as a hydraulic unit for an ABS/ESP brake regulation system.

### SUMMARY

The present invention creates a valve body for a braking system of a motor vehicle, having at least one passthrough opening for receiving a contact pin for electrically connecting an electric motor and a control device of a hydraulic unit of the braking system of the motor vehicle, the at least one passthrough opening extending from a first side of the valve body facing toward the electric motor to a second side of the valve body facing toward the control device; and having an insulating element that is embodied to insulate the contact pin with respect to a surface of the at least one passthrough opening, the insulating element being embodied integrally with the at least one passthrough opening.

The present invention furthermore creates a hydraulic unit for a braking system of a motor vehicle, having the valve body according to the present invention, having an electric motor, and having a control device for applying control to the electric motor and to the valve body.

An idea of the present invention is that fastening of the insulating element to the contact pin, for electrical connection of the electric motor and the control device, can be omitted thanks to the integral configuration of the insulating element with the at least one passthrough opening of the valve body. An area on the contact pin that would be necessary for overmolding or latching is no longer necessary. An increase in efficiency and a cost reduction are achieved in the context of installation of the electric motor on the valve body and in the context of passage of the contact pin through the passthrough opening embodied in the valve body; and insertion of the contact pin into a receptacle of the control device is simplified because the tolerances between the electric motor, valve body, and control device are improved. Conventionally, a dimensional discrepancy between a plug-in contact for receiving the contact pin in the control device, and the passthrough opening in the valve body, must be compensated for. That dimensional discrepancy must be compensated for by the insulation of the contacts in order to prevent distortion between the respective parts in a maximum tolerance situation. Because the insulating element is configured integrally, according to the present invention, with the passthrough opening of the valve body, the contact pin of the electric motor can thus be passed in simple fashion through the valve body. The contact pin can thus be inserted with high positioning accuracy into the respective plug-in contact in the control device. Because the contact pin is not fixedly connected to the insulating element but is merely passed through the insulating element, distortion between the respective parts in a maximum tolerance situation can be prevented.

According to a preferred refinement, provision is made that the insulating element is inserted in positionally fixed fashion into the at least one passthrough opening, a length of the insulating element being less than or equal to a length of the at least one passthrough opening. Positionally fixed insertion of the insulating element into the at least one passthrough opening thus makes it possible for the insulating element to be securely fastened in the valve body, and fastening to the contact pin of the electric motor can therefore be omitted.

According to a further preferred refinement, provision is made that the insulating element is constituted by a plastic sleeve through which the at least one contact pin is passable. Constituting the insulating element as a plastic sleeve or plastic tube advantageously allows a considerable cost reduction compared with conventional solutions.

According to a further preferred refinement, provision is made that the insulating element is inserted in nonpositively, positively, or intermaterially engaging fashion into the at least one passthrough opening. Simple and secure fastening of the insulating element in the at least one passthrough opening of the valve body can thereby advantageously be ensured, and fastening of the insulating element in the at least one passthrough opening can be adapted to any structural requirements of the valve body.

According to a further preferred refinement, provision is made that the insulating element is staked to the valve body at an axial end portion of the at least one passthrough opening. The insulating element can thereby be immobilized, after insertion into the at least one passthrough opening of the valve body, in positionally fixed fashion therein.

According to a further preferred refinement, provision is made that the at least one passthrough opening is constituted by a stepped bore, the at least one passthrough opening having a first diameter at a first axial portion and a second diameter, which is smaller than the first diameter, at a second axial portion. Because the passthrough opening is configured as a stepped bore, the insulating element can advantageously be inserted into the passthrough opening from that side of the passthrough opening which has the first diameter, and can thus be fastened in the passthrough opening in the region of the diameter reduction of the passthrough opening, i.e. the transition from the first diameter to the second diameter. The insulating element can thus be prevented from sliding out of the passthrough opening.

According to a further preferred refinement, provision is made that the insulating element has a diameter reduction on an inner circumference, the insulating element having a first diameter at a first axial portion and a second diameter, which is smaller than the first diameter, at a second axial portion. The advantageous result of configuring the insulating element with the diameter reduction is that a correspondingly embodied contact pin that likewise exhibits a diameter reduction, or exhibits a first and a second diameter at different axial portions, can be inserted into the insulating element in such a way that the contact pin is immobilizable, or disposable in positionally fixed fashion, in an axial direction in the insulating element.

According to a further preferred refinement, provision is made that the insulating element is inserted into the at least one passthrough opening by way of a press fit. The insulating element can thus be fastened in the at least one passthrough opening, alternatively to the provision of a stepped bore or to staking of the valve body in the region of the passthrough opening, by way of the press fit, and thereby secured against axial shifting in the passthrough opening.

According to a further preferred refinement, provision is made that the contact pin is immobilized by a press fit in the region of an opening, in which the contact pin is inserted, of a housing of the electric motor. Installation of the contact pin on the electric motor can thus be simplified, since after insertion into the opening of the housing of the electric motor, the contact pin is immobilized in an axial direction by the press fit, and the contact pin is thus prevented from shifting axially or sliding out of the opening of the housing of the electric motor.

According to a further preferred refinement, provision is made that the contact pin has a first diameter at a first axial portion and a second diameter, which is smaller than the first diameter, at a second axial portion, the diameter reduction of the insulating element forming a stop for the first axial portion of the contact pin. The contact pin can thereby advantageously be fastened in the insulating element in an axial direction in the region of the diameter reduction of the contact pin.

According to a further preferred refinement, provision is made that the contact pin is centered in the insulating element in such a way that a gap is constituted between a housing of the valve body and the contact pin at respective emergence points from the at least one passthrough opening. The gap advantageously ensures that the contact pin does not contact the housing of the valve body outside the insulating element.

The embodiments and refinements that have been described can be combined in any way with one another.

Further possible embodiments, refinements, and implementations of the invention also encompass combinations, not explicitly recited, of features of the invention which are described above or hereinafter regarding the exemplifying embodiments.

### BRIEF DESCRIPTION OF THE DRAWINGS

The appended drawings are intended to provide further comprehension of the embodiments of the invention. They illustrate embodiments, and in conjunction with the description serve to explain principles and concepts of the invention.

Other embodiments, and many of the advantages recited, are evident in light of the drawings. The elements of the drawings which are depicted are not necessarily shown accurately to scale with one another.

FIG. 1 is an exploded view of a hydraulic unit in accordance with a preferred embodiment of the invention.

FIG. 2 is a section view of section plane A-A, shown in FIG. 1, of the hydraulic unit in an assembled state, in accordance with the preferred embodiment of the invention.

FIG. 3 is an enlarged depiction of the section view shown in FIG. 2, in accordance with the preferred embodiment of the invention.

FIG. 4 schematically depicts a contact pin, inserted into a passthrough opening of the valve body, at an axial end portion of the passthrough opening, in accordance with the preferred embodiment of the invention.

### DETAILED DESCRIPTION

In the Figures, identical reference characters designate identical or functionally identical elements, components, or constituents unless indicated to the contrary.

FIG. 1 is an exploded view of a hydraulic unit in accordance with a preferred embodiment of the invention.

Hydraulic unit 1 for the braking system of the motor vehicle has a valve body 10, an electric motor 2, and a control device 3 for applying control to electric motor 2 and to valve body 10.

Hydraulic unit 1 furthermore has a linkage that is connected to electric motor 2 and drives a pump or plunger apparatus.

Valve body 10 has a passthrough opening 12 for receiving a contact pin 14 of electric motor 2. Contact pin 14 of electric motor 2 serves to electrically connect electric motor 2 and control device 3 of hydraulic unit 1. When hydraulic unit 1 is in the assembled state, electric motor 2 is disposed on a first side 10a of valve body 10. When hydraulic unit 1 is in the assembled state, control device 3 is disposed on valve body 10 on a second side 10b of valve body 10. Valve body 10 furthermore has a housing 10c.

In addition, when hydraulic unit 1 is in the assembled state, a plurality of valves 4 are inserted into corresponding openings of valve body 10. Control device 3 furthermore has a board 3a on which corresponding receptacles for valves 4 are disposed.

When hydraulic unit 1 is in the assembled state, contact pin 14 of electric motor 2 extends through passthrough opening 12 from first side 10a of valve body 10 facing toward electric motor 2 to second side 10b of valve body 10 facing toward control device 3; and on second side 10b of valve 10 facing toward control device 3 it emerges from valve body 10 and is received in control device 3 in a plug-in contact (not shown in FIG. 1).

Valve body 10 furthermore has an insulating element (not shown in FIG. 1) that is embodied to insulate contact pin 14 with respect to a surface of passthrough opening 12. The insulating element is embodied integrally with passthrough opening 12. Alternatively to the provision of a passthrough opening 12 in valve body 10, for example, a plurality of passthrough openings can be provided in valve body 10.

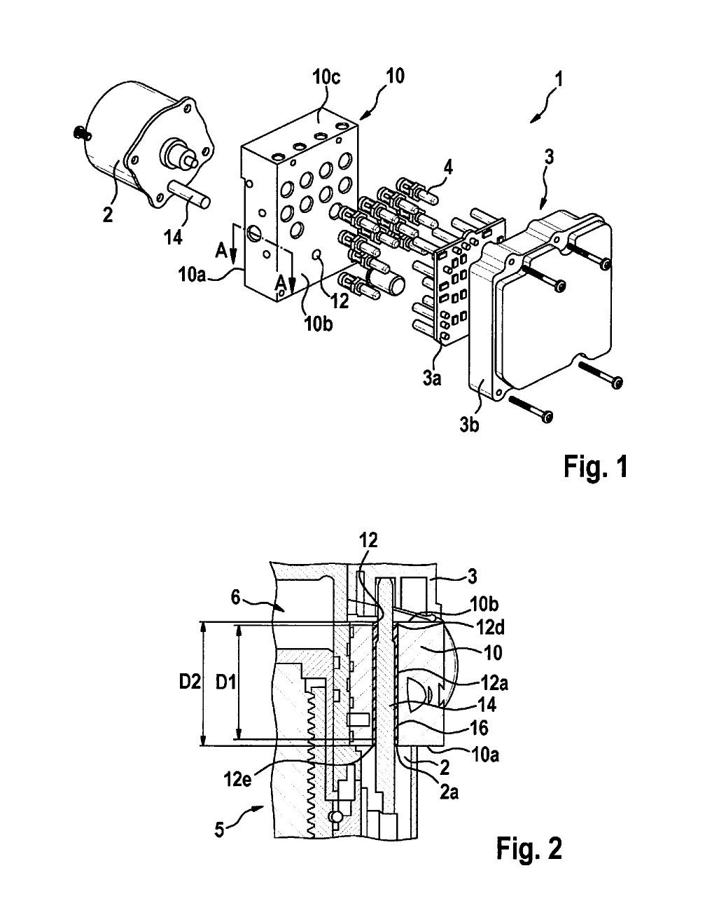

FIG. 2 is a section view of section plane A-A, shown in FIG. 1, of the hydraulic unit in the assembled state, in accordance with the preferred embodiment of the invention.

Also provided in the depiction according to FIG. 2, in addition to valve body 10 and electric motor 2, is a spindle drive 5, likewise connected nonrotatably to electric motor 2, for driving a plunger apparatus 6, which drive is embodied to generate a hydraulic pressure in valve body 10.

Contact pin 14 of electric motor 2 for electrically connecting electric motor 2 and control device 3 of hydraulic unit 1 is depicted in the assembled state in FIG. 2. In this context, contact pin 14 is inserted into passthrough opening 12 of valve body 10 in such a way that it is passed through insulating element 16 that is inserted into passthrough opening 12 or embodied integrally with passthrough opening 12. Contact pin 14 is thereby insulated from surface 12a of passthrough opening 12.

Insulating element 16 is inserted in positionally fixed fashion into passthrough opening 12. A length L1 of insulating element 16 is preferably shorter than a length L2 of passthrough opening 12. Alternatively, the length of insulating element 16 can correspond, for example, to the length of passthrough opening 12.

Insulating element 16 is preferably constituted by a plastic sleeve, i.e. a plastic tube, through which contact pin 14 is passed.

Insulating element 16 is preferably inserted in positively engaging fashion in passthrough opening 12. Alternatively, insulating element 16 can be inserted, for example, in nonpositively or intermaterially engaging fashion into passthrough opening 12.

Passthrough opening 12 is constituted by a stepped bore. Passthrough opening 12 has a first diameter D1 at a first axial portion 12b and a second diameter D2, which is smaller than first diameter D1, at a second axial portion 12c.

Alternatively to staking of insulating element 16 in passthrough opening 12, and to the provision of the stepped bore in passthrough opening 12, it is conceivable, for example, to insert insulating element 16 into passthrough opening 12 by way of a press fit.

Contact pin 14 is furthermore immobilized by a press fit in the region of an opening 2a of a housing of electric motor 2 into which contact pin 14 is inserted.

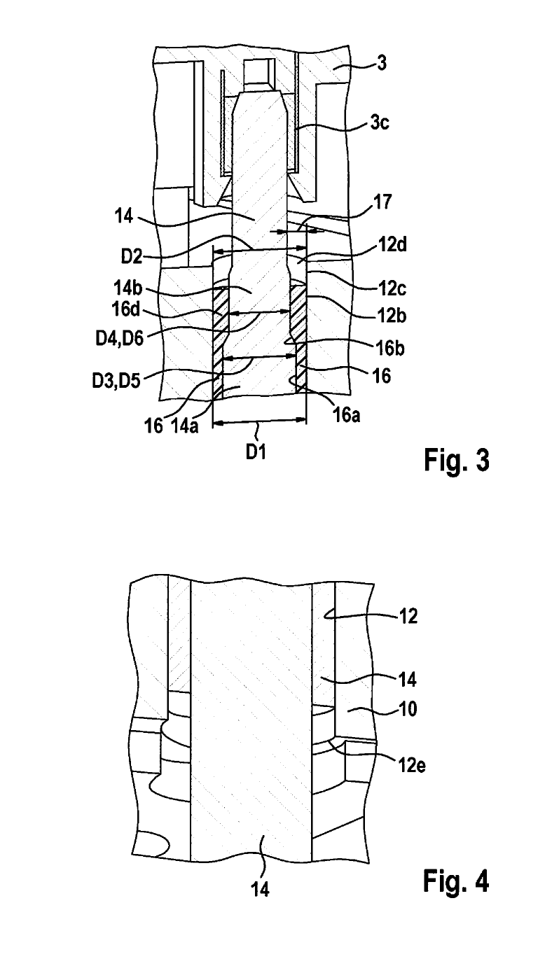

FIG. 3 is an enlarged depiction of the section view shown in FIG. 2, in accordance with the preferred embodiment of the invention.

Insulating element 16 has a diameter reduction 16b on an inner circumference 16a. Insulating element 16 furthermore has a first diameter D3 at a first axial portion 16c and a second diameter D4 at a second axial portion 16d. Second diameter D4 is smaller than first diameter D3.

Contact pin 14 has a first diameter D5 at a first axial portion 14a, and a second diameter D6 at a second axial portion 14b. Second diameter D6 is smaller than first diameter D5. Diameter reduction 16b of insulating element 16 thus forms a stop for the first axial portion of contact pin 14. Contact pin 14 is centered in insulating element 16 in such a way that a gap 17 is constituted between a housing 10c of valve body 10 and contact pin 14 at respective emergence points 12d, 12e from the passthrough opening.

FIG. 4 schematically depicts a contact pin, inserted into a passthrough opening of the valve body, at an axial end portion of the passthrough opening, in accordance with the preferred embodiment of the invention.

Insulating element 16 is staked to valve body 10 at an axial end portion 12e of passthrough opening 12. Alternatively, as described above, insulating element 16 can be inserted into passthrough opening 12 of valve body 10, for example, by way of a press fit.

Although the present invention has been described above with reference to preferred exemplifying embodiments, it is not limited thereto but is instead modifiable in numerous ways. In particular, the invention can be changed or modified in a multiplicity of ways without deviating from the essence of the invention.

For example, a manner in which insulating element 16 is fastened in passthrough opening 12 of valve body 10, and a material of insulating element 16, can be modified or adapted to particular structural or design-related requirements of hydraulic unit 1.

1.-12. (canceled)

13. A valve body for a braking system of a motor vehicle, comprising:
at least one passthrough opening for receiving a contact pin for electrically connecting an electric motor and a control device of a hydraulic unit of the braking system of the motor vehicle, wherein the at least one passthrough opening extends from a first side of the valve body facing toward the electric motor to a second side of the valve body facing toward the control device; and
an insulating element for insulating the contact pin with respect to a surface of the at least one passthrough opening, wherein the insulating element is integral with the at least one passthrough opening.

14. The valve body as recited in claim 13, wherein:
the insulating element is inserted in positionally fixed fashion into the at least one passthrough opening, and
a length of the insulating element being less than or equal to a length of the at least one passthrough opening.

15. The valve body as recited in claim 13, wherein the insulating element includes a plastic sleeve through which the at least one contact pin is passable.

16. The valve body as recited in claim 13, wherein the insulating element (16) is inserted in one of a nonpositively, a positively, and an intermaterially engaging fashion into the at least one passthrough opening.

17. The valve body as recited in claim 13, wherein the insulating element is staked to the valve body at an axial end portion of the at least one passthrough opening.

18. The valve body as recited in claim 17, wherein:
the at least one passthrough opening includes a stepped bore,
the at least one passthrough opening includes a first diameter at a first axial portion and a second diameter at a second axial portion, and
the second diameter is smaller than the first diameter.

19. The valve body as recited in claim 13, wherein:
the insulating element includes a diameter reduction on an inner circumference,
the insulating element includes a first diameter at a first axial portion and a second diameter at a second axial portion, and
the second diameter is smaller than the first diameter.

20. The valve body as recited in claim 13, wherein the insulating element is inserted into the at least one passthrough opening by way of a press fit.

21. A hydraulic unit for a braking system of a motor vehicle, comprising:
an electric motor;
a control device; and
a valve body for a braking system of a motor vehicle, the valve body including:
at least one passthrough opening for receiving a contact pin for electrically connecting an electric motor and a control device of a hydraulic unit of the braking system of the motor vehicle, wherein the at least one passthrough opening extends from a first side of the valve body facing toward the electric motor to a second side of the valve body facing toward the control device, and
an insulating element for insulating the contact pin with respect to a surface of the at least one passthrough opening, wherein the insulating element is integral with the at least one passthrough opening, wherein the control device applies control to the electric motor and to the valve body.

22. The hydraulic unit as recited in claim 21, wherein the contact pin is immobilized by a press fit in a region of an opening, in which the contact pin is inserted, of a housing of the electric motor.

23. The hydraulic unit as recited in claim 21, wherein:
the contact pin has a first diameter at a first axial portion and a second diameter at a second axial portion,
the second diameter is smaller than the first diameter, and
a diameter reduction of the insulating element forms a stop for the first axial portion of the contact pin.

24. The hydraulic unit as recited in claim 21, wherein:
the contact pin is centered in the insulating element in such a way that a gap is present between a housing of the valve body and the contact pin at respective emergence points from the at least one passthrough opening.
